(19) United States
(12) Patent Application Publication
(10) Pub. No.: US 2025/0125651 A1
(43) Pub. Date: Apr. 17, 2025

(54) SYSTEMS AND METHODS FOR REAL TIME ESTIMATION OF POTENTIAL HIGH LIMIT OF CURTAILED INVERTERS AND POWER SETPOINT ALLOCATION FOR FLEXIBLE OPERATION AND DISPATCH OF INVERTER BASED RESOURCES

(71) Applicant: Latimer Controls, Inc., Boulder, CO (US)

(72) Inventors: Simon Julien, Denver, CO (US); Zachary Jacobs, Denver, CO (US); Tristan Liu, Burlingame, CA (US); Desmond Manthy, San Francisco, CA (US)

(21) Appl. No.: 18/912,083

(22) Filed: Oct. 10, 2024

Related U.S. Application Data
(60) Provisional application No. 63/543,707, filed on Oct. 11, 2023.

(51) Int. Cl. H02J 13/00; G05B 13/02

(52) U.S. Cl. CPC H02J 13/00002; G05B 13/0265; H02J 2203/20

(57) ABSTRACT

A method is for controlling a power plant based on a potential high limit (PHL) of the power plant. The method includes generating synthetic data based on a plurality of predetermined models, each of which is for a specific environment in a power plant, training the machine learning algorithm with the synthetic data, receiving current measurement values of current and voltage at the inverters during a curtailment period, building a model of the function relationship between current and voltage, by the machine learning algorithm, based on previous measurement values and current measurement values, based on the built model, estimating a PHL of each inverter in the power plant, by the machine learning algorithm, and controlling the power plant, based on the estimated PHL.

### CROSS-REFERENCE TO RELATED APPLICATIONS

This application claims the benefit of and priority to U.S. Provisional Patent Application Ser. No. 63/543,707 filed on Oct. 11, 2023, and entitled “SYSTEMS AND METHODS FOR REAL TIME ESTIMATION OF POTENTIAL HIGH LIMIT OF CURTAILED INVERTERS AND POWER SETPOINT ALLOCATION FOR FLEXIBLE OPERATION AND DISPATCH OF INVERTER BASED RESOURCES,” which is expressly incorporated herein by reference in its entirety.

### TECHNICAL FIELD

The present disclosure relates generally to systems, methods, and computer-readable media for a power plant operation, and particularly for estimating a potential high limit of the power generation in cases when power output is curtailed.

### BACKGROUND AND RELEVANT ART

Power plants that rely on an unsteady power generation availability, such as solar power plants, face challenges due to the changing and unpredictable nature of the source of energy. Real-time variability of environmental factors and scenarios such as irradiance, temperature, the degradation of plant components over time, over-generation, transmission constraints, and grid balancing can lead grid operators to intentionally curtail power output.

By setting an arbitrary upper limit on the power output, flexible solar plants follow generation signals from the grid operator instead of operating at a maximum power point at all times. However, conventional power plant controls do not provide reliable estimates of the power plant's potential high limit (PHL)—the maximum amount of power that could be produced under given operating conditions—when the power plant is curtailed. Without this information, plant operators are unable to effectively manage power setpoints or have visibility over how much additional generation could be made available if curtailment restrictions were lifted.

### BRIEF SUMMARY OF THE INVENTION

Various aspects of the present disclosure are directed to methods for estimating a potential high limit (PHL) of a power plant during a curtailment period. By employing a machine learning or artificial intelligence algorithm, the PHL may be estimated with limited measurement data due to the curtailment period. According to various aspects, the method for controlling a power plant based on a potential high limit (PHL) of the power plant is disclosed. The method includes generating synthetic data based on a plurality of predetermined models, each of which is for an environment in a power plant, training the machine learning algorithm with the synthetic data, receiving current measurement values of current and voltage at the inverters during a curtailment period, building a model of a functional relationship between current and voltage, by the machine learning algorithm, based on previous measurement values and current measurement values, based on the built model, estimating a PHL of each inverter in the power plant, by the machine learning algorithm, and controlling the power plant, based on the estimated PHL.

According to various aspects, a method for controlling a power plant by estimating a potential high limit (PHL) of the power plant is disclosed. The method includes receiving measurement values of current and voltage from inverters and environment data from associated sensors, timestamping the received measurement values and the environment data, training and updating the machine learning algorithm with the timestamped measurement values and the environment data, receiving current measurement values of current and voltage from the inverters and current environment data from the associated sensors during a curtailment period, building a model of a functional relationship between current and voltage, by the updated machine learning algorithm, based on previous and current measurement values and previous and current environment data, based on the built model, estimating, by the updated machine learning algorithm, a PHL for each inverter, and controlling the power plant based on estimated PHLs.

According to further aspects, a system for controlling a power plant by estimating a potential high limit (PHL) of the power plant is disclosed. The system includes one or more processors and a memory including instructions. When executed by the one or more processors, the instructions cause the system to generate synthetic data based on a plurality of predetermined models, each of which is for an environment in a power plant, train the machine learning algorithm with the synthetic data, receive current measurement values of current and voltage at the inverters during a curtailment period, build a model of a functional relationship between current and voltage, by the updated machine learning algorithm, based on previous measurement values and current measurement values, based on the built model, estimate the PHL at the inverters, by the machine learning algorithm, and control the power plant, based on the estimated PHL.

Additional features and advantages will be set forth in the description which follows, and in part will be obvious from the description, or may be learned by practice. The features and advantages may be realized and obtained by means of the instruments and combinations particularly pointed out in the appended claims. These and other features will become more fully apparent from the following description and appended claims, or may be learned by the practice of the examples as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific various aspects thereof which are illustrated in the appended drawings. It should be noted that the figures are not drawn to scale, and that elements of similar structure or function are generally represented by like reference numerals for illustrative purposes throughout the figures. Understanding that these drawings depict only typical various aspects of the invention and are not therefore to be considered to be limiting of its scope, the invention will be described and explained with additional specificity and detail through the use of the accompanying drawings in which:

FIG. 1 illustrates a block diagram of a system for controlling a power plant according to various aspects of the present disclosure.

FIG. 2 illustrates a graphical representation of a potential high limit of power without a curtailment order according to various aspects of the present disclosure.

FIG. 3 illustrates a graphical representation of a potential high limit (PHL) of power with a curtailment order according to various aspects of the present disclosure.

FIG. 4 illustrates a series of graphical representations of a series of I-V and P-V data points used to estimate the PHL during a curtailment order according to various aspects of the present disclosure.

FIG. 5 illustrates a graphical representation of a series of I-V and P-V data points used to estimate the PHL during a curtailment order according to various aspects of the present disclosure.

FIG. 6 illustrates a schematic workflow for estimating a PHL based on measured data points according to various aspects of the present disclosure.

FIG. 7 illustrates graphical representations of data plots under various environmental conditions for estimating a PHL according to various aspects of the present disclosure.

FIG. 8 illustrates a data plot with previous data points to estimate a PHL according to various aspects of the present disclosure.

FIG. 9 illustrates a series of graphical representations showing improvement on estimation of a PHL through iterations over a PHL prediction process according to various aspects of the present disclosure.

FIG. 10 illustrates a flowchart of a method for estimating a PHL utilizing a model based on synthetically generated data for a power plant under a curtailment order according to various aspects of the present disclosure.

FIG. 11 illustrates a flowchart of a method for estimating a PHL utilizing a model based on historical generation data for a power plant under a curtailment order according to various aspects of the present disclosure.

FIG. 12 illustrates a block diagram of a computing system according to various aspects of the present disclosure.

### DETAILED DESCRIPTION OF THE PREFERRED VARIOUS ASPECTS

Implementations of the present invention solve one or more of the foregoing problems in the art with flexible solar plant operations and allow for a reliable, accurate estimate of a potential high limit (PHL) while the power plant is curtailed. The available power output from the power plant can be described using I-V (current and voltage) and a P-V (power and voltage) data plots. The full data plots are known when there is no curtailment order in place (i.e., when the power plant is operating at the maximum power point (MPP)), and the voltage of the power plant may be adjusted frequently to keep the power plant at or near the PHL to maximize power output.

When an arbitrary curtailment order is issued from a grid operator, the PHL is not readily available and must instead be estimated. During normal operation of the power plant, data is recorded at frequent, short intervals such as once every second. This time series data is stored on an ongoing basis during normal operation in preparation for a curtail order. When the curtailment order is issued, the recent stored data is used to estimate the PHL as follows. The machine learning model utilizes previously stored data (usually the past few seconds and including the present power setpoint) to generate an I-V data plot and thus extrapolate the maximum power point for the given data plot. For purposes of explanation and not limitation, a system for estimating the PHL for the power plant accesses the previous 10 timestamped data values with 1 second interval between each. The number of timestamped data values and the interval between can vary as needed.

Aspects of the present disclosure, such as the examples disclosed herein, may be beneficial in a variety of respects. For example, and as will be apparent from the present disclosure, one or more aspects of the present disclosure may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention. Rather, various aspects of the present disclosure may be combined in a variety of ways so as to define yet further aspects. Such further aspects are considered as being within the scope of this disclosure. As well, none of the aspects embraced within the scope of this disclosure should be construed as resolving, or being limited to the resolution of, any particular problems. Nor should any such aspects be construed to implement, or be limited to implementation of, any particular technical effects or solutions. Finally, it is not required that any aspects implement any of the advantageous and unexpected effects disclosed herein.

It is also noted that aspects of the present disclosure, whether claimed or not, cannot be performed, practically or otherwise, in the mind of a human. Accordingly, nothing herein should be construed as teaching or suggesting that any aspect of the present disclosure could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

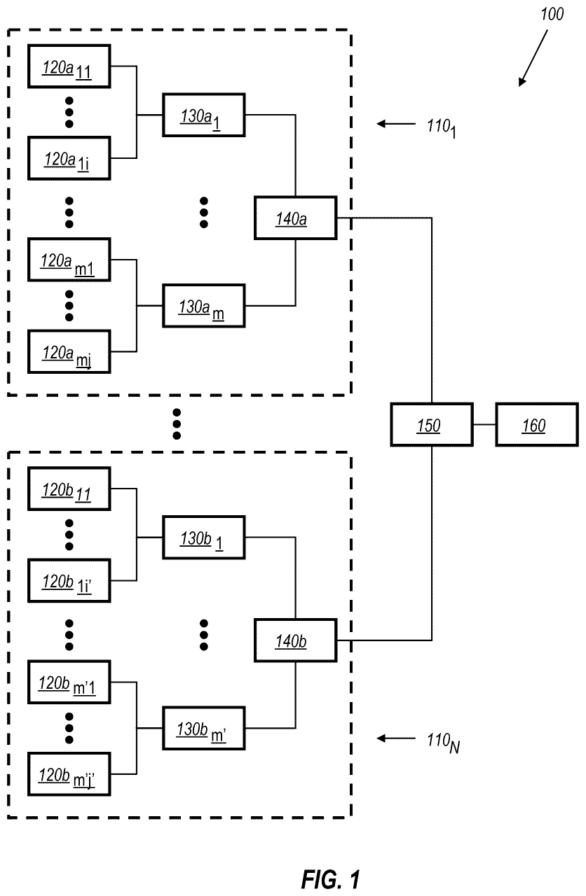

FIG. 1 illustrates a system 100 for controlling power plants 110₁-110_{N} according to various aspects of the present disclosure. The system 100 may utilize a machine learning algorithm to control generation of power in the power plants 110₁-110_{N}. The power plants 110₁-110_{N} may be illustrated as solar power plants in FIG. 1. The power plants 110₁-110_{N} are not, however, limited to the solar power plants but may utilize inverter-based resources such as wind energy, battery energy storage systems, and other energy generation or storage technologies. In an aspect, the power plants 110₁-110_{N} may include a combination of renewable source generators and conventional power generators. Hence, the power plants 110₁-110_{N} may further include nuclear energy, fossil energy, etc. The description of the solar power plants 110₁-110_{N}, as will be described below, may be similarly applicable to other renewable or conventional power plants with small variations therefrom, which is readily understandable by persons having ordinary skill in the power generation technology.

The power generation by each of the power plants 110₁-110_{N} may vary based on various environmental factors. For example, in a case where the power plants 110₁-110_{N} include solar photovoltaic modules, the power plants 110₁-110_{N} may generate higher power when the weather is sunny than when the weather is cloudy. Pollutions in the air may decrease the power generation. When shades are over a portion of the solar photovoltaic modules, such solar photovoltaic modules may generate less power than without the shades. Further, extreme weather (e.g., too hot or too cold) may affect performance of electrical components in the solar photovoltaic modules, thereby affecting the power generation. Power generation by wind turbines may likewise vary based on environmental factors such as a velocity of wind and the orientation of the wind turbine with respect to the wind direction. These environmental factors are provided as examples and may include other factors specific for each power plant without departing from the scope of this disclosure.

The system 100 may control the power plants 110₁-110_{N} via a control server 160. The power plants 110₁ may include one or more solar photovoltaic modules or solar panels 120a₁₁-120bₘⱼ. A group of solar photovoltaic modules (e.g., 120a₁₁-120a₁ᵢ) may be connected to a corresponding inverter (e.g., 130a₁) of the inverters 130a₁-130b_{m′}. The number of solar photovoltaic modules connected to one inverter may be different from the number of solar photovoltaic modules connected to another inverter within the power plant 110₁. The inverters 130a₁-130aₘ are controlled by a power plant controller 140a.

It is noted that when one or more alphanumerals are attached at the end of three-digit reference numerals, individual elements are referred, and when one or more alphanumerals are not attached at the end of the three-digit reference numerals, collective or representative elements are referred. Also, apostrophe “′” right after an alphabet in a reference numeral may indicate that the reference numeral with apostrophe is different from the reference numeral without the alphabet. For example, 130bₘ may be different from 130b_{m′}. Further, “i,” “i′,” “j,” “j′,” “m,” and “m′” represent any integer value greater than or equal to 1.

The power plant 110_{N} may include one or more solar photovoltaic modules or solar photovoltaic modules 120b₁₁-120b_{m′j′}. A group of solar photovoltaic modules (e.g., 120b₁₁-120b₁ᵢ) may be connected to a corresponding inverter (e.g., 130b₁) of the inverters 130b₁-130b_{m′}. The number of solar photovoltaic modules connected to one inverter may be different from the number of solar photovoltaic modules connected to another inverter within the power plant 110_{N}. The inverters 130b₁-130b_{m′} are controlled by a power plant controller 140b.

When the inverter 130a₁ may control the number “i” of the solar photovoltaic modules 120a₁₁-120a₁ᵢ different from the number “j” of the solar photovoltaic modules 120aₘ₁-120aₘⱼ by the inverter 130aₘ, the power generated by the solar photovoltaic modules 120a₁₁-120a₁ᵢ and inverted by the inverter 130a₁ may be different from the power generated by the solar photovoltaic modules 120aₘ₁-120aₘⱼ and inverted by the inverter 130aₘ. Thus, each inverter 130 may be differently controlled from each other. Likewise, the total power generated by the power plant 110₁ may be different from the total power generated by the power plant 110_{N}, and thus each power plant 110 may be differently controlled from each other. Thus, without knowing the PHL of each inverter 130, the total maximum power output by each power plant 110 is unknown and control of the power plants 110 may be impractically and inefficiently performed.

In an aspect, each inverter 130 may be connected to only one solar photovoltaic module 120. In this case, the data resolution of the measurement data may be higher than a case where one inverter 130 is connected to two or more solar photovoltaic modules 120. The more the number of solar photovoltaic modules are connected to each inverter 130, the less the data resolution of the measurement data becomes.

In another aspect, based on environmental factors including weather, location, temperature, wind velocity, barometer, tidal difference, amount of water flow, etc., each power plant 110 may be controlled differently. The environmental factors may include degraded efficiency of each electronic component of the solar photovoltaic module 120, the inverter 130, and the power plant controller 140. As time goes by or malfunctions, wears, or tears in each electronic component occur, the efficiency or performance level is resultantly decreased, thereby affecting the power generation. These pieces of environment data may be sensed by corresponding sensors installed or integrated thereon. For example, a current sensor and a voltage sensor may be installed or integrated on the inverter 130 so that measurement values of the current and voltage generated by the solar photovoltaic modules 120 and inverted by the inverters 130 may be measured. Temperature sensors may be installed at a site where the power plants 110 are located, and measure the temperature at the site. Other environment data such as weather may be obtained via the Internet from corresponding websites.

The acquisition server 150 may acquire measurement data from the inverters 130 and the environment data from sensors via network connection, wireless or wired. In an aspect, the acquisition server 150 may acquire data once every predetermined period (e.g., 1 second, 10 seconds, 20 seconds, 1 minute, 2 minutes, 5 minutes, 10 minutes, or any other period) based on the needs of the system 100. The acquired data may be saved in a database or log. In an aspect, the acquired data may be stored in a cloud storage or in a distributed ledger so that integrity and immutability of the acquired data may be preserved.

The acquired data may be transmitted to the control server 160, which analyzes the acquired data and controls the power plants 110 via a grid control framework such as automatic generation control (AGC), advanced distribution management system (ADMS), or other grid control system. One of the primary operational challenges for the power plants 110 arises when power output from the power plants 110 needs to be curtailed due to various factors, such as grid congestion, over-generation, or the need to maintain operational reserves. Curtailment orders often require the power plants 110 to reduce power generation below their maximum generation potential, which complicates efforts to optimize energy production. In these conditions, the control server 160 or the operator have to balance the need to comply with the curtailment orders while still maximizing the amount of power generated and dispatched by the power plants 110.

In response to the curtailment orders, the power plant controller 140 may employ machine learning or artificial intelligence algorithms. The machine learning algorithm may incorporate several advanced machine learning techniques, which include supervised learning, unsupervised learning, reinforcement learning, or other forms of adaptive learning. The supervised learning model may be initially trained using labeled data, where the input variables (e.g., voltage, current, power, temperature, weather, etc.) are associated with known output values (e.g., maximum power point or potential high limit (PHL)). This allows the supervised learning model to learn the relationships between the input and output variables and make accurate predictions in real-time. In addition to the supervised learning model, the unsupervised learning model may also use unsupervised learning techniques to identify patterns and relationships in the data that may not be explicitly labeled. This allows the unsupervised model to detect subtle changes in power generation by each inverter 130 that may be caused by factors such as degradation, environmental variability, or grid conditions.

Additionally, or alternatively, the adaptive learning model may incorporate adaptive learning techniques that enable adaptation to new data as it becomes available. As the adaptive learning model collects real-time measurements from the inverters 130, it compares the predicted PHL with the actual measurements and adjusts its internal parameters to improve accuracy. This continuous feedback loop allows the adaptive learning model to refine its predictions over time and adapt to changing conditions.

In aspects, the power plant controller 140 may utilize synthetic data in training machine learning algorithms for the power plant 110. Due to numerous environmental conditions, it is not practically feasible to obtain measurement data under all environmental conditions. Thus, based on an ideal model for each condition, ideal or synthetic data may be generated and the power plant controller 140 may train the machine learning algorithm with the synthetic data. By training the machine learning algorithm with the synthetic data based on every possible condition, the power plant controller 140 may train a machine learning algorithm with ideal environmental conditions and may be able to adjust internal parameters of the ideal machine learning algorithm as measurement data is acquired. By doing so, the machine learning algorithm is adjusted to accommodate real environmental factors and may be able to predict a potential high limit (PHL) of the power plant 110 under any condition with higher accuracy.

The synthetic data may include current, voltage, power, and environment data under each condition. The machine learning algorithm may be updated as measurement data from the power plant 110 and real environment data from the corresponding sensors. In instances, the synthetic data may be obtained from publicly available data from hardware similar to the hardware that is in the solar photovoltaic modules 120 of the power plants 110, and from which the estimation of the PHL can be obtained. Solar photovoltaic modules 120 may include hardware used to operate solar power plants, and model numbers are well documented. Thus, the corresponding information may be readily available from the manufacturers. The hardware may have periodic updates to the hardware configuration, and in some various aspects, the revision of the hardware would be regularly made and readily available.

After the machine learning algorithm has been trained, the power plant controller 140 may utilize historic measurement data and current measurement data to adjust or further train the machine learning algorithm. In this case, a predetermined number of previous measurement data may be used. For example, the predetermined number may be 10, 20, 30, 40, or any suitable number. The higher the predetermined number of previous measurement data is, the more accurate the prediction will be. However, after a certain number of the historic measurement data, the accuracy of the prediction may not be advanced and increase the calculation burden. The predetermined number may be less than 10.

Additionally, or alternatively, the power plant controller 140 may utilize an adaptive learning model, which allows the power plant controller 140 to improve the pre-trained model, which has been trained based on the synthetic data. For example, the adaptive learning model may use the following modified Shockley diode equation:

$$I = {I}_{0} [ {e}^{\frac{q V}{n k T}} - 1 ] - IL ,$$

where I represents a predicted current value, I₀ is the previous current value, V is a currently measured voltage value, k is the Boltzmann constant, Tis the absolute temperature in Kelvin, q is the elementary charge, n is an ideality factor, which is 1 for indirect semiconductors and 2 for direct semiconductors, and IL is light illumination. While the Shockley diode equation has been used for semiconductors, the above modified Shockley diode equation is for the solar photovoltaic module 120 and their aggregated power equivalent and each variable (e.g., q, n, k, T, and IL) may be determined by the adaptive learning algorithm. As a result, based on the currently measured voltage value, variables in the modified Shockley diode equation are adjusted by the adaptive learning model so as to provide the predicted current value I.

The modified Shockley diode equation is nonlinear, making it difficult to solve directly in real-time applications. To overcome the real-time difficulties, the adaptive learning model may use numerical methods, such as Newton-Raphson, bisection, or other iterative methods to predict the current value/based on the voltage value V.

When a curtailment order or a requested power, which is smaller than the total power generated by the power plants 110, the power plant controller 140 may utilize the adaptive learning model to generate and transmit an order to each inverter 130. Specifically, based on the PHL of each inverter 130, the power plant controller 140 may determine a power set point for each inverter 130 and distribute the power set points into all inverters 130 of the power plants 110 so that the total of the power set points is equal to the requested power. It is noted that the PHL of each power plant 110 is the sum of the PHLs of all inverters 130 within the power plant 110.

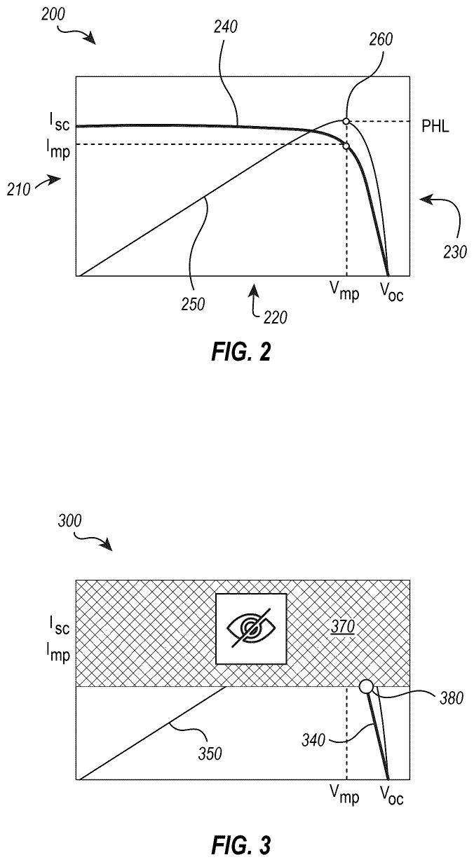

FIG. 2 illustrates a graphical representation 200 of a power plant operating without a curtailment order, while FIG. 3 illustrates a graphical representation 300 of a power plant operating with a curtailment order according to various aspects of the present disclosure. A left vertical axis 210 represents current (I), a horizontal axis 220 represent voltage (V), and a right vertical axis 230 represent power (P), which is a product of the current I and the voltage V. An I-V data plot 240 represents a data plot of current versus voltage, and a P-V data plot 250 represents a data plot of power versus voltage.

Based on the I-V data plot 240, the current I is substantially maintained at a constant level, Isc, along the horizontal axis 220 until a certain voltage and rapidly decreases to zero at voltage=Voc after the certain voltage. Thus, the P-V data plot 250 initially increases linearly along the horizontal axis 220, reaches a maximum, which is the potential high limit (PHL) positioned at voltage=Vmp and current=Imp, and rapidly decreases to zero at voltage=Voc. Thus, without the curtailment order, the entire range of I-V data plot 240 and P-V data plot 250 are known and the PHL may be directly measured.

The graphical representation 300 includes an I-V data plot 340, a P-V data plot 350, and an occluded region 370 that illustrates the lack of knowledge of current and voltage at the inverters and power plant controllers due to the curtailment order. Further, due to the occluded region, the PHL may be also hidden and thus is unknown based on the non-occluded regions of the I-V data plot 340 and the P-V data plot 350. The curtailment order may come from a grid operator and may include a parameter specifying a degree of curtailment which can be given in terms of a do-not-exceed limit with units of power. For example, a curtailment order for a 100 MW capacity power plant may specify reducing power to 80 MW, i.e., curtailing the power by 20 MW. Above the curtailment threshold 380 (a.k.a., P_{curtailed}), the state of the inverters and power plant controllers have no knowledge of the I-V data plot 340 and the P-V data plot 350, and no knowledge of which I and V pair constitute the maximum power point. For this reason, the PHL of the power plant cannot be directly measured and may instead be approximated, estimated, or predicted by the control system (e.g., the power plant controller 140 of FIG. 1).

The P-V data plot 350 of the power output from the power plant shows the curtailment order in place, and the occluded region 370 above the curtailment threshold P_{curtailed} 380. The known portions of the I-V data plot 340 and the P-V data plot 350 are below the curtailment threshold P_{curtailed} 380. The power plant operates by changing the voltage (on the horizontal axis) and the power output is resultantly affected by the product of the voltage and the current. The highest known point on the P-V data plot 350 is the curtailed power point or the curtailment threshold P_{curtailed} 380. If the power plant were to decrease the voltage from voltage=Vmp, the power output would exceed the curtailment threshold P_{curtailed} 380. Increasing the voltage from voltage=Vmp would result in the power output decreasing along the I-V data plot 340. It is possible to operate above the curtailed limit, but doing so would violate the curtailment threshold P curtailed 380. The I-V data plot 340 and the P-V data plot 350 exist within the occluded region 370, but the precise shape of the data plots is not known, giving rise to the need for estimation of the PHL.

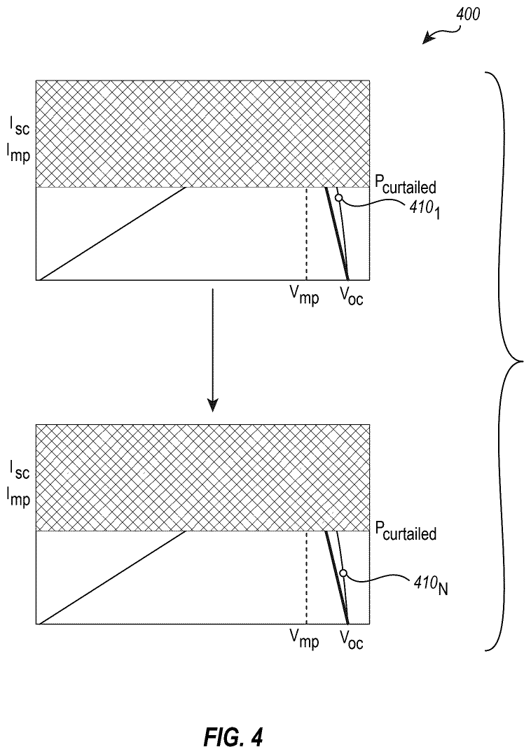

FIG. 4 illustrates a series 400 of current and voltage or power points 410₁-410_{N}, which are timestamped and used to estimate the PHL during a curtailment order according to various aspects of the present disclosure. The timestamped I-V data points 410₁-410_{N} may be stored in reverse chronological order, with the most recent I-V data point or the power value 410₁ being the first, the next most recent I-V data points or the power value being the second, and so forth up to and including the N-th I-V data points or the power value 410_{N} within the data plot under the occluded region. Any arbitrary number of data pair points may be used, and the interval between two adjacent data pair points may also vary. In various aspects, the series 400 may include 10 consecutive I-V data points, and the interval, at which the data points are being stored, may be 1 second or higher time resolution. The number N may be greater than or less than 10. It is noted that the data plot is not known at measurements of the I-V data points 410₁-410_{N} but are shown in FIG. 4 for explaining purposes.

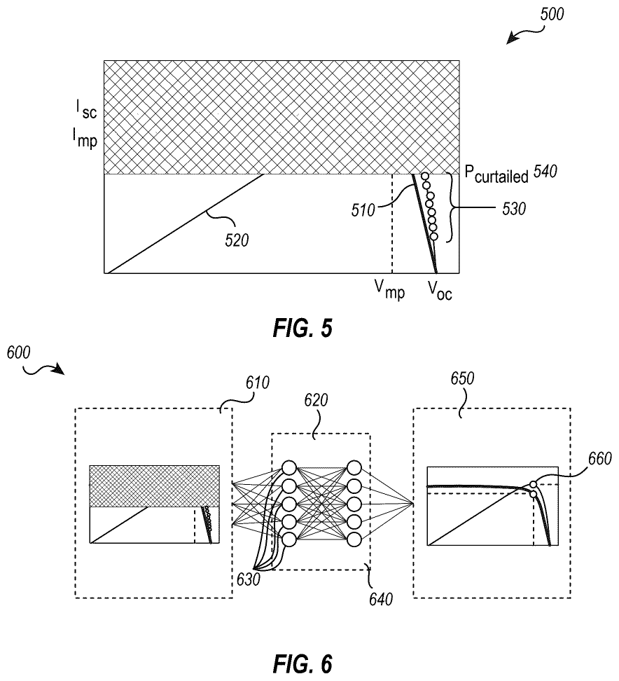

FIG. 5 illustrates a graphical representation 500, which includes an I-V data plot 510 and a P-V data plot 520 showing power data points 530 from the series of previous timestamped I-V data points according to various aspects of the present disclosure. The I-V data plot 510 and the P-V data plot 520 are occluded in a region above a curtailment threshold P_{curtailed} 540, and a series of power data points 530 are plotted on the P-V data plot 520. The P-V data plot 520 is shown here for explanation, but the precise data plot is not known at this point in the process. The power plant controller 140 of the present disclosure uses the power data points 530 to generate this P-V data plot 520, which is used to estimate the PHL. To achieve the PHL, the power plant controller may use a machine learning algorithm with any architecture that is tuned for performance by a data set including a multitude of P-V and I-V data plots which are compared to the series of power data points 530 to find a best-fitting data plot, which is then used to estimate the PHL.

FIG. 6 illustrates a schematic workflow 600 showing how a machine learning algorithm may be able to predict or estimate a PHL using recent, timestamped I-V data points from the power plant according to various aspects of the present disclosure. The schematic workflow 600 may include a first phase 610, in which a certain number of previously recorded, timestamped I-V data are obtained to produce a series of power data points (e.g., the power data points 530 of FIG. 5) on the P-V data plot. The workflow may further include a second phase 620, which is a machine learning algorithm including previously trained machine learning layers. The number of the inside machine learning layers may be determined based on the series of training data points but hidden in the structure itself. The machine learning layers may include an input layer 630 receiving inputs from the first phase and an output layer 640 outputting outputs to a third phase 650.

In aspects, the training data may be generated based on an ideal model under one environmental condition. The training data may include environment data identifying the environmental conditions and the corresponding ideal I-V data points and/or power data points. Further, the training data may include all possible environmental conditions. Since it is not feasible to generate real-life data points under all possible environmental conditions, the training data may be made synthetically or generated by a computer according to ideal models.

Parameters of solar photovoltaic modules may be used to generate the synthetic data, and may include a nominal module operating temperature, a cell area, a cell type (e.g., a half-cut mono crystalline cell, etc.), an open circuit current, an open circuit voltage, a nominal power current, a nominal power voltage, a temperature coefficient of the short circuit current, a temperature coefficient of the open circuit voltage, a diode ideality factor, a light-generated current at reference conditions, a series resistance of the solar photovoltaic cell, a shunt resistance of the solar photovoltaic cell, a calibration coefficient, a nominal power, a temperature coefficient of the nominal power, a type of technology (e.g., Mono-c-Si, etc.), and the likes.

The machine learning algorithm 620 may be updated and adjusted based on measurement data (e.g., the I-V data points), thereby incorporating the real environmental conditions into the machine learning algorithm 620. The machine learning algorithm 620 may use deep learning algorithms, artificial neural networks, supervised or unsupervised adaptive algorithms, or any other suitable machine learning or artificial intelligence algorithms.

In the third phase 650, the pre-trained machine learning algorithm may use the outputs from the output layer 640 to find a best fitting I-V data plot for the input data points, estimate or predict a maximum power point of a P-V data plot based on the best fitting I-V data plot, and thus conclude on the PHL of each inverter. The P-V data points (e.g., the power data points 530 of FIG. 5) may not be necessarily analogous to the inputs to the input layer 630 of the machine learning algorithm as illustrated in FIG. 6 and should not be labeled as such. Instead, the P-V data points or I-V data points may be pre-processed to be inputs to the input layer 630.

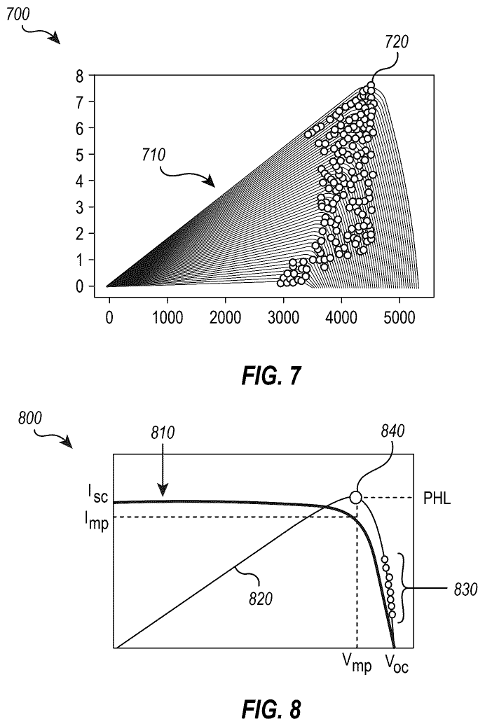

FIG. 7 illustrates a graphical representation 700 of P-V data plots 710 under all possible environmental conditions according to various aspects of the present disclosure. The P-V data plots 710 may be obtained from an ideal solar photovoltaic module that is similar to those (e.g., the solar photovoltaic module 120 of FIG. 1) in the power plant. In this example case, the model number of the module from which the P-V data plot 710 have been obtained, is “REC375TP2SM 72.” This module has been chosen due to its physical and operational similarity to the solar photovoltaic module of the power plant that may be subjected to a curtailment order. Similarly, an ideal solar inverter may be used to directly measure the operation range of I-V and P-V data plots. The machine learning algorithm may be trained on the synthetic data and create or find a data plot that best fits the series of data points obtained from timestamped real-life data points before or during the curtailment order took place. Thereby, the estimation or prediction of the PHL 720 may be enabled from the vest fitting data points.

In some various aspects, the data plots for the solar photovoltaic module may include measurements for each data plot that pertain to conditions surrounding the power generation at that time. For example, temperature and irradiation are factors that influence power generation of solar power plants. Accordingly, each data plot may include parameters describing temperature and irradiation measurements for that data plot. This additional data, as environment data, may be fed to the machine learning algorithm to identify a data plot that even more accurately matches the conditions at the power plant. The closer the temperature and irradiation parameters are to the current conditions under the curtailment order, and the continuing, up-to-the-second measurements during the curtailment order, the better the estimation or prediction of the P-V data plot and the PHL are.

The machine learning algorithm may continue to operate into the curtailment period by using successive timestamped data points as a continuous input. For example, suppose that the number of timestamped data points is 10, the interval between two adjacent data points is one second, and the curtailment order is received at time 0:00, the first iteration of the estimation uses the data points in the previous ten seconds, in a set timestamped as:
−0:10;
−0:09;
−0:08;
−0:07;
−0:06;
−0:05;
−0:04;
−0:03;
−0:02; and
−0:01.

The second iteration of the estimation uses:
−0:09;
−0:08;
−0:07;
−0:06;
−0:05;
−0:04;
−0:03;
−0:02; and
−0:01
−0:00.

The third iteration of the estimation uses:
−0:08;
−0:07;
−0:06;
−0:05;
−0:04;
−0:03;
−0:02;
−0:01;
0:00; and
0:01.

The fourth iteration of the estimation uses:
−0:07;
−0:06;
−0:05;
−0:04;
−0:03;
−0:02;
−0:01;
0:00;
0:01; and
0:02.

For each second of operational time, the previous N timestamped data points may be used as inputs, resulting in a continuous estimation that is updated once every interval. In some various aspects, the value of N may be 10, 20, 30, or any other suitable number, and the interval between timestamps may be 1, 2, 3, 4, 5, or 10 seconds, or any suitable time interval.

FIG. 8 illustrates an I-V data plot 810 and a P-V data plot 820 with a series of curtailed power data points 830 from the previous N timestamped data points according to various aspects of the present disclosure. The P-V data plot 820 may be obtained from the machine learning algorithm based on the curtailed power data points 830 from the previous N timestamped data points as inputs, and a PHL 840 may be estimated from the P-V data plot 820, which is the best fit data plot based on the N timestamped data points. Since the previous N timestamped data points are used for the estimation, a continuously updated estimation of the PHL is made possible during the curtailment order and the PHL may be used to inform power setpoint allocation for each inverter, for the purpose of precisely meeting power commands as set forth by the grid operator. Additionally, the PHL may be used by the grid operator to have an overview over the solar power plant or solar fleet's instantaneously available active power reserves. The PHL estimation thus achieved can be more reliable and accurate than other methods such as a regression or a data plot fit because the data points are constantly updated, and the machine learning algorithm continues to improve as it iterates.

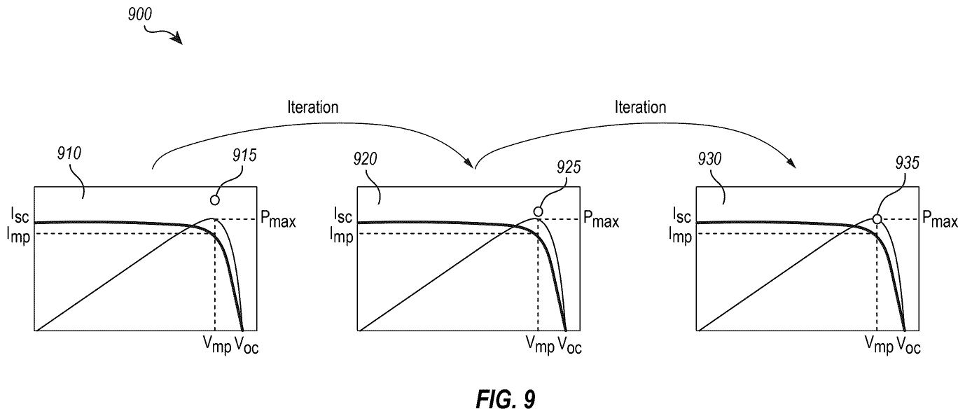

FIG. 9 illustrates improvements in PHL estimation based on a series of data plots as the estimation iterations through the machine learning algorithms according to various aspects of the present disclosure. The first graphical representation 910 is for the first iteration, the second graphical representation 920 is for the second iteration, and the third graphical representation 930 is for the third iteration. The PHL estimations 915, 925, and 935 in the graphical representations 910-930 become closer to the true PHL as more iterations are performed.

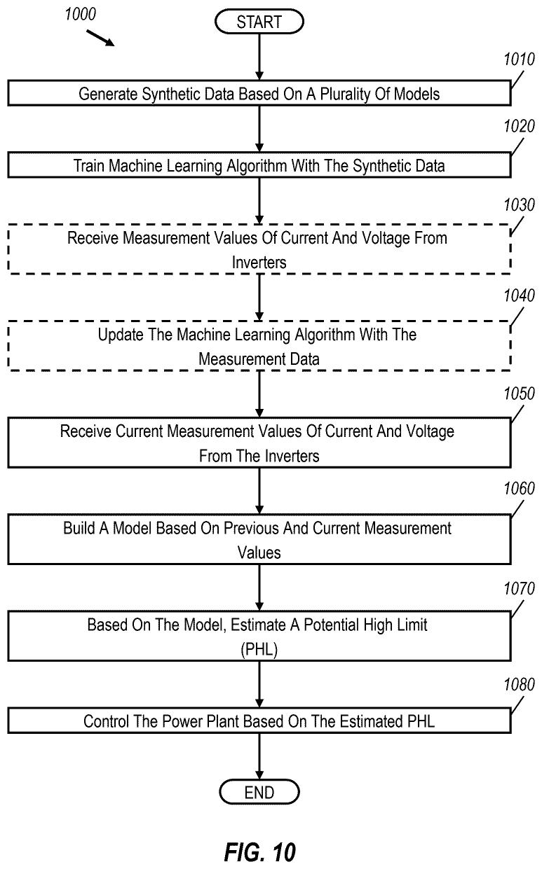

FIG. 10 illustrates a flowchart of a method 1000 for estimating a PHL for a power plant under a curtailment order according to various aspects of the present disclosure. The method 1000 may include acts that can be implemented by a control server (e.g., the control server 160 of FIG. 1), which may be a computing device, a server, or a cloud server, by on-site control hardware (e.g., the power plant controller 140 of FIG. 1), or may be implemented as Software as a Service (“SaaS”), Platform as a Service (“PaaS”), or Infrastructure as a Service (“IaaS”).

The method 1000 may comprise an act 1010, at which synthetic data is generated based on a plurality of environmental models. The environmental models may include external conditions, which may include but are not limited to temperature, weather, irradiance, soiling, forecasts, or measurements from nearby locations or power plants. The synthetic data may also include lab-generated data points of current, voltage, and power under each ideal environmental condition or model, which is based on a mathematical model.

For example, the synthetic data may include power generation data points under sunny, rainy, hot, cold, cloudy, foggy, dusty, clean, snowy, smoky, or any other weather conditions. Further, the synthetic data may include chronological data points for the 24-hour for every predetermined period in each weather condition. The predetermined period may be 1, 2, 3, 4, 5, or 10 seconds, less than 1 second, or greater than 10 seconds. Further, malfunctions or common manufacturing defects of each electrical component in the solar photovoltaic module may be included in the environmental conditions. In other words, there is an environmental model corresponding to the malfunctions or the manufacturing defects. The synthetic data may grow as new environmental conditions are added.

In some instances, the synthetic data may be obtained from publicly available data from hardware similar to the hardware of the solar photovoltaic modules and inverters, and from which the estimation of the PHL under an ideal condition may be obtained. Generally, model numbers of the hardware of the solar photovoltaic modules and inverters are well documented, and the corresponding information is readily available. The hardware may have periodic updates to the hardware configuration, and the revision of the hardware may also be used for updating the synthetic data.

In further instances, historic measurement data may be used as the synthetic data after grouping the historic measurement data based on similar environmental conditions. By grouping the historic measurement data and using the grouped historic measurement data, more realistic data may be reflected on the synthetic data under corresponding environmental conditions. However, if the amount of measurement data in the same group is not sufficient to train the machine learning algorithm, such measurement data in the group may not be added to the synthetic data.

The method 1000 may further comprise an act 1020 of training a machine learning algorithm with the synthetic data, which includes the data points and the environment data. At this stage, the machine learning algorithm may be trained with ideal data and needs to be adjusted to reflect real life measurement data and conditions later.

The method 1000 may further comprise an act 1030, at which measurement data points of current and voltage may be received from inverters of the power plant. The measurement data points are examples of the real life data. In aspects, the act 1030 may further receive environment data including temperature, irradiation, weather, location, etc. from corresponding sensors or websites via Internet.

The method 1000 may further comprise an act 1040 of updating the machine learning algorithm with the measurement data, which may be timestamped. The updating step may also use previous N number of timestamped data points. In a case there are no previous measurement data points, the most recent N number of synthetic data points may be used.

It is noted that the acts 1030 and 1040 are illustrated in dotted lines, implying that the acts 1030 and 1040 may be optionally performed. Thus, the acts 1030 and 1040 may not be performed or may be performed within other one or more acts described below.

The method 1000 may further comprise an act 1050 of receiving current measurement data points of current and voltage from inverters under the curtailment order, similar to the receiving step at the act 1040. The power data point may be measured or calculated by multiplying the current and the voltage. Due to the curtailment order, a data plot corresponding to the current environment data includes an occluded region, thereby the PHL is not readily available at this point.

The method 1000 may further comprise an act 1060, at which the machine learning algorithm may find a model that best-fits to the current measurement data points and previous N measurement data points. In aspects, while finding the best fit model, the machine learning algorithm may update the internal parameters based on the current measurement data points of the current and the voltage as at act 1040.

The method 1000 may further comprise an act 1070 of estimating the potential high limit (PHL) of the inverter based on the best fit model obtained from the act 1060 by extrapolating the PHL based on the I-V data point pairs. For example, out of many models as illustrated in the P-V data plots 710 of FIG. 1, the machine learning algorithm may build the best fit model such as the P-V data plot 820 of FIG. 8 based on the current measurement data points and the previous N measurement data points. Also, the accuracy of the PHL may be improved as more iterations are performed as illustrated in FIG. 9.

The act 1070 may further include iterating at a desired time interval the estimation step based on new measurement values. Since the estimation step is performed continuously, updating the machine learning algorithm is also performed continuously.

The method 1000 may still further comprise an act 1080 of controlling the power plant based on the estimated PHLs for the inverters in the power plant. Specifically, when a requested power is less than the total power generation, which is the sum of PHLs of all inverters in the power plant, the machine learning algorithm may determine or allocate a power set point for each inverter and cause the power plant controller to control each inverter to generate the allocated power set point. Thereby, the sum of the allocated power set points may be equal to the requested power. Since the method 1000 continues to update the machine learning algorithm based on new measurement data points of the current and the voltage, the accuracy of the estimation of the PHL may be improved.

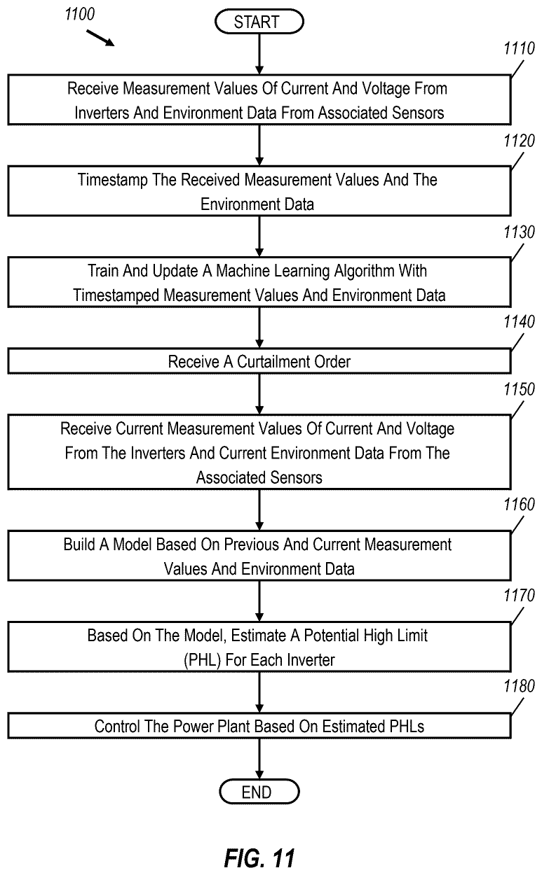

While the machine learning algorithm is trained based on synthetic data according to the method 1000 of FIG. 10, the machine learning algorithm may be trained based on measurement data only. FIG. 11 illustrates a method 1100 of training the machine learning algorithm based on the measurement data points according to various aspects of the present disclosure. The method 1100 may comprise an act 1110 of receiving measurement data points of current and voltage from inverters of the power plant and environment data from corresponding sensors. In an aspect, weather data may be obtained from a weather website or a weather server via the Internet. The measurement data points may have been generated for at least a predetermined period of time, which may be 2 months for every second, 6 months for every second, or any suitable time period sufficient for training the machine learning algorithm.

The method 1100 may further comprise act 1120 of timestamping the received measurement data points and the environment data. The most recent data may be timestamped as the first in the database or log. The measurement data and the environment data may be stored in a distributed ledger so that they cannot be easily tempered and compromised. The storage medium for the measurement data and the environment data may be local or remote in a storage server or in the cloud. The timestamping may be performed according to a predetermined interval, which may be 1, 2, 3, 4, 5, or 10 seconds, less than one second, or greater than 10 seconds. The shorter the predetermined interval is, the higher the data resolution can be.

In aspects, the time interval for the measurement data may be different from the time interval for the environment data. Generally, the time interval for the environment data may be longer than the time interval for the measurement data because the environmental conditions tend to be steadier than the measurement data. Further, the time interval for one factor (e.g., the weather conditions) of the environment data may be longer than the time interval for another factor (e.g., temperature). Nevertheless, in a case where the environmental conditions change rapidly, the time interval for the environment data may be adjusted to be shorter than that of the measurement data. In this wise, the machine learning algorithm may request or obtain the environment data according to a time interval for a respective factor.

The method 1100 may further comprise an act 1130, at which the machine learning algorithm is trained and updated based on the timestamped measurement data and the timestamped environment data. In aspects, the machine learning algorithm may utilize an adaptive learning model, which updates or tunes up the machine learning algorithm, which has been trained based on the measurement data at the act 1130. For example, the adaptive learning model may use the modified Shockley diode equation. The training and updating may be performed by adjusting internal parameters of the machine learning algorithm.

The method 1100 may further comprise an act 1140 of receiving a curtailment order. The curtailment order may come from the solar power plant owner, a grid operator, or any other balancing authority or partner tasked with issuing such orders. The curtailment orders may be based on an unsteady operating condition such as unstable temperature or irradiation parameters. The curtailment order may also include an energy management system, such as automatic generation control (AGC) advanced distribution management system (ADMS) or distributed energy resource management system (DERMS), requests to provide grid services, in which the curtailment order is refreshed within 1-60 second intervals. In deregulated markets with a transmission or distribution system operator (TSO or DSO), an independent solar operator may choose to curtail their solar assets in order to avoid over-generation and any associated balancing fees accrued on the open energy marketplace.

The method 1100 may further comprise an act 1150 of receiving recent or current measurement data, such as current and voltage, from the inverters of the power plant. The current measurement data may be stored in a memory specifically dedicated for estimating a PHL during the curtailment order. The recent or current environment data may be also received from associated sensors at the act 1150.

Based on the current measurement data and the current environment data together with previous N measurement data and environment data, the machine learning algorithm may build a model, which best fits to the previous and current measurement and environment data, at an act 1160. The method 1100 may employ a regression deep neural network to train and update the machine learning algorithm by updating and adjusting values of internal parameters. Since the act 1160 is performed every time when new measurement data is received, the machine learning algorithm may be likewise updated and internal parameters thereof are also adjusted at every desired time interval.

The method 1100 may further comprise an act 1170 of estimating a PHL for each inverter based on the best fit model. The PHL is the highest point attainable on the P-V data plot of the best fit model during the curtailment order. Each inverter may have a different PHL from other inverters. The machine learning algorithm may estimate the PHL for each inverter, determine a power set point, and distribute the power set points into all inverters of the power plants so that the total of the power set points is equal to the requested power during the curtailment order. It is noted that the PHL of each power plant is the sum of the PHLs of all inverters within the power plant.

In an aspect, based on a ratio between the total power generation by the power plant and the requested power, the power set points may be set by reducing the corresponding PHLs according to the ratio. In this instance, it is required to make sure that the power set points meet the curtailment threshold. In another aspect, the machine learning algorithm may set the power set point for each inverter by deducting the same amount from the PHL so that the power set points are lower than or equal to the curtailment threshold and the sum of all power set points is equal to the requested power. The ways to determine the power set points are not limited to these two methods and may include other suitable ways, which can be readily appreciated by those skilled in the art, to meet the requested power and/or the curtailment threshold.

The method 1100 may further comprise an act 1180 of controlling the power plant based on the power set points for all the inverters via the power plant controllers. In this way, even when the curtailment order is received, power generation is efficiently performed according to the requested power.

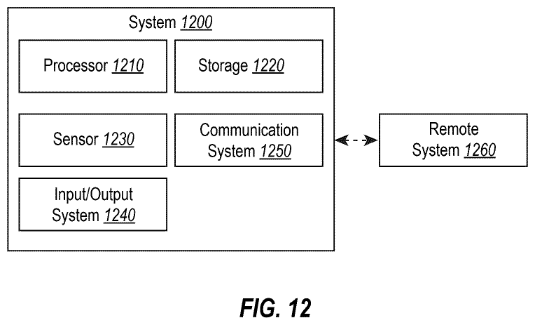

FIG. 12 illustrates example components of a computing system 1200 that may comprise or implement one or more various aspects of the present disclosure. For example, FIG. 12 illustrates an implementation in which the system 1200 may include a processor 1210, a storage 1220, one or more sensors 1230, an I/O system 1240, and a communication system 1250. Although FIG. 12 illustrates the system 1200 as including particular components, one will appreciate, in view of the present disclosure, that the system 1200 may further comprise any number of additional or alternative components.

The processor 1210 may comprise one or more sets of electronic circuitries that include any number of logic units, registers, and/or control units to facilitate the execution of computer-readable instructions (e.g., instructions that form a computer program). Such computer-readable instructions may be stored within the storage 1220. The storage 1220 may comprise one or more computer-readable recording media and may be volatile, non-volatile, or some combination thereof. Furthermore, storage 1220 may comprise local storage, remote storage (e.g., accessible via the communication system 1250 or otherwise), or some combination thereof. Additional details related to the processors (e.g., the processor 1210) and computer storage media (e.g., the storage 1220) will be provided hereinafter.

As will be described in more detail, the processor 1210 may be configured to execute instructions stored within the storage 1220 to perform certain actions. In some instances, the actions may rely at least in part on the communication system 1250 for receiving data from a remote system 1260, which may include, for example, separate systems or computing devices, sensors, and/or others. The communication system 1250 may comprise any combination of software or hardware components that are operable to facilitate communication between on-system components/devices and/or with off-system components/devices. For example, the communication system 1250 may comprise serial, parallel, USB, IEEE 1394, firewire, ethernet, infrared, or any other ports, buses, or other physical connection apparatuses for communicating with other devices/components. Additionally, or alternatively, the communication system 1250 may comprise systems/components operable to communicate wirelessly with external systems and/or devices through any suitable communication channel, such as, by way of non-limiting example, Bluetooth, ultra-wideband, WLAN, infrared communication, radiofrequency, and/or others.

FIG. 12 illustrates that the system 1200 may comprise or be in communication with the sensors 1230. The sensors 1230 may comprise any device for capturing or measuring data points of perceivable phenomena. By way of non-limiting example, the sensors 1230 may comprise one or more image sensors, microphones, thermometers, barometers, magnetometers, accelerometers, gyroscopes, current sensors, voltage sensors, electric power sensors, moisture sensors, irradiation sensors, and/or others.

Furthermore, FIG. 12 illustrates that the system 1200 may comprise or be in communication with the I/O system 1240. The I/O system 1240 may include any type of input or output devices such as, by way of non-limiting example, a display, a touch screen, a mouse, a keyboard, a controller, and/or others, without limitation.

Following are some further example aspects of the present disclosure. These are presented only by way of example and are not intended to limit the scope of the invention in any way.

Clause 1. A method for controlling a power plant based on a potential high limit (PHL) of the power plant, the method comprising: generating synthetic data based on a plurality of predetermined models, each of which is for an environment in a power plant; training a machine learning algorithm with the synthetic data; receiving current measurement values of current and voltage at inverters of the power plant during a curtailment period; building a model of a functional relationship between current and voltage, by the machine learning algorithm, based on previous measurement values and current measurement values; based on the built model, estimating a PHL of each inverter in the power plant, by the machine learning algorithm; and controlling the power plant, based on the estimated PHL.

Clause 2. The method of clause 1, wherein the power plant includes, a solar plant, a wind farm, a geothermal power plant, a hydroelectric power plant, a combustion power plant, and any combination thereof.

Clause 3. The method of any of clauses 1-2, wherein the environment includes temperatures, weather, shades, wind velocities, a location of the power plant, wear and tear of electrical components, or general manufacturing defects.

Clause 4. The method of any of clauses 1-3, wherein the previous measurement values are measured for a predetermined period right before the current measurement values.

Clause 5. The method of any of clauses 1-4, wherein the machine learning algorithm is trained based on a relationship between the current and voltage.

Clause 6. The method of any of clauses 1-5, wherein the relationship is defined by an equation: where I is a predicted current value, I0 is a previous current value, V is a currently measured voltage value, k is a Boltzmann constant, T is an absolute temperature in Kelvin, q is an elementary charge, n is an ideality factor, which is 1 for indirect semiconductors and 2 for direct semiconductors, and IL is light illumination.

Clause 7. The method of any of clauses 1-6, wherein the machine learning algorithm is updated based on the predicted current value and the current measurement current value.

Clause 8. The method of any of clauses 1-7, wherein the machine learning algorithm is updated by adjusting parameters in the equation.

Clause 9. The method of any of clauses 1-8, wherein the synthetic data includes ideal values of current and voltage at the inverters under respective environment in the power plant.

Clause 10. The method of any of clauses 1-9, wherein controlling the power plant is performed by allocating a power set point for each inverter based on an estimated PHL for the power plant.

Clause 11. A method for control a power plant by estimating a potential high limit (PHL) of the power plant, the method comprising: receiving measurement values of current and voltage from inverters and environment data from associated sensors; timestamping the received measurement values and the environment data; training and updating a machine learning algorithm with the timestamped measurement values and the environment data; receiving current measurement values of current and voltage from the inverters and current environment data from the associated sensors during a curtailment period; building a model of a functional relationship between current and voltage, by the updated machine learning algorithm, based on previous and current measurement values and previous and current environment data; based on the built model, estimating, by the updated machine learning algorithm, a PHL for each inverter; and controlling the power plant based on estimated PHLs.

Clause 12. The method of clause 11, wherein the power plant includes, a solar plant, a wind farm, a geothermal power plant, a hydroelectric power plant, a combustion power plant, and any combination thereof.

Clause 13. The method of any of clauses 11-12, wherein the environment includes temperatures, weather, shades, wind velocities, a location of the power plant, wear and tear of electrical components, or general manufacturing defects.

Clause 14. The method of any of clauses 11-13, wherein the previous measurement values have been measured for a predetermined period right before the current measurement values.

Clause 15. The method of any of clauses 11-14, wherein the machine learning algorithm is trained based on a relationship between the current and voltage.

Clause 16. The method of any of clauses 11-15, wherein the relationship is defined by an equation: where I is a predicted current value, I0 is a previous current value, V is a currently measured voltage value, k is a Boltzmann constant, T is an absolute temperature in Kelvin, q is an elementary charge, n is an ideality factor, which is 1 for indirect semiconductors and 2 for direct semiconductors, and IL is light illumination.

Clause 17. The method of any of clauses 11-16, wherein the machine learning algorithm is updated based on the predicted current value and the current measurement current value.

Clause 18. The method of any of clauses 11-17, wherein the machine learning algorithm is updated by adjusting parameters in the equation.

Clause 19. The method of any of clauses 11-18, wherein controlling the power plant is performed by allocating a power set point for each inverter based on an estimated PHL for the power plant.

Clause 20. A system for controlling a power plant by estimating a potential high limit (PHL) of the power plant, the system comprising: one or more processors; and a memory including instructions that, when executed by the one or more processors, cause the system to: generate synthetic data based on a plurality of predetermined models, each of which is for an environment in a power plant; train a machine learning algorithm with the synthetic data; receive current measurement values of current and voltage at inverters of the power plant during a curtailment period; build a model of the function relationship between current and voltage, by the machine learning algorithm, based on previous measurement values and current measurement values; based on the built model, estimate the PHL at the inverters, by the machine learning algorithm; and control the power plant, based on the estimated PHL.

The following discussion is intended to provide a brief, general description of a suitable computing environment in which the present disclosure may be implemented. Although not required, the present disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the present disclosure may be practiced in network computing environments with many types of computer system configurations, including personal computers, hand-held devices, multi-processor systems, microprocessor-based or programmable consumer electronics, network PCs, minicomputers, mainframe computers, and the like. The present disclosure may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

The present disclosure may comprise or utilize a special-purpose or general-purpose computer system that includes computer hardware, such as, for example, a processor and system memory, as discussed in greater detail below. The scope of the present disclosure also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the present disclosure can comprise two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the present disclosure.

Transmission media can include a network and/or data links which can be used to carry program code in the form of computer-executable instructions or data structures, and which can be accessed by a general-purpose or special-purpose computer system. A “network” is defined as data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module, and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the present disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The present disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the present disclosure may be practiced in a cloud-computing environment. Cloud computing environments may be distributed. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes a host that is capable of running virtual machines. During operation, virtual machines emulate an operational computing system, supporting an operating system and perhaps other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine interfaces with the appearance (e.g., a virtual resource) of a physical resource. Examples of physical resources including processing capacity, memory, disk space, network bandwidth, media drives, and so forth.

The present disclosure may be embodied in other specific forms without departing from its spirit or essential characteristics. The described examples are to be considered in all respects only as illustrative and not restrictive. The scope of the present disclosure is, therefore, indicated by the appended claims rather than by the foregoing description. All changes which come within the meaning and range of equivalency of the claims are to be embraced within their scope.

We claim:

1. A method for controlling a power plant based on a potential high limit (PHL) of the power plant, the method comprising:
generating synthetic data based on a plurality of predetermined models, each of which is for an environment in a power plant;
training a machine learning algorithm with the synthetic data;
receiving current measurement values of current and voltage at inverters of the power plant during a curtailment period;
building a model of a functional relationship between current and voltage, by the machine learning algorithm, based on previous measurement values and current measurement values;
based on the built model, estimating a PHL of each inverter in the power plant, by the machine learning algorithm; and
controlling the power plant, based on the estimated PHL.

2. The method of claim 1, wherein the power plant includes, a solar plant, a wind farm, a geothermal power plant, a hydroelectric power plant, a combustion power plant, and any combination thereof.

3. The method of claim 1, wherein the environment includes temperatures, weather, shades, wind velocities, a location of the power plant, wear and tear of electrical components, or general manufacturing defects.

4. The method of claim 1, wherein the previous measurement values are measured for a predetermined period right before the current measurement values.

5. The method of claim 1, wherein the machine learning algorithm is trained based on a relationship between the current and voltage.

6. The method of claim 5, wherein the relationship is defined by an equation:
$$I = {I}_{0} [ {e}^{\frac{q V}{n k T}} - 1 ] - IL ,$$
where I is a predicted current value, I₀ is a previous current value, Vis a currently measured voltage value, k is a Boltzmann constant, T is an absolute temperature in Kelvin, q is an elementary charge, n is an ideality factor, which is 1 for indirect semiconductors and 2 for direct semiconductors, and IL is light illumination.

7. The method of claim 6, wherein the machine learning algorithm is updated based on the predicted current value and the current measurement current value.

8. The method of claim 6, wherein the machine learning algorithm is updated by adjusting parameters in the equation.

9. The method of claim 1, wherein the synthetic data includes ideal values of current and voltage at the inverters under respective environment in the power plant.

10. The method of claim 1, wherein controlling the power plant is performed by allocating a power set point for each inverter based on an estimated PHL for the power plant.

11. A method for control a power plant by estimating a potential high limit (PHL) of the power plant, the method comprising:
receiving measurement values of current and voltage from inverters and environment data from associated sensors;
timestamping the received measurement values and the environment data;
training and updating a machine learning algorithm with the timestamped measurement values and the environment data;
receiving current measurement values of current and voltage from the inverters and current environment data from the associated sensors during a curtailment period;
building a model of a functional relationship between current and voltage, by the updated machine learning algorithm, based on previous and current measurement values and previous and current environment data;
based on the built model, estimating, by the updated machine learning algorithm, a PHL for each inverter; and
controlling the power plant based on estimated PHLs.

12. The method of claim 11, wherein the power plant includes, a solar plant, a wind farm, a geothermal power plant, a hydroelectric power plant, a combustion power plant, and any combination thereof.

13. The method of claim 11, wherein the environment includes temperatures, weather, shades, wind velocities, a location of the power plant, wear and tear of electrical components, or general manufacturing defects.

14. The method of claim 11, wherein the previous measurement values have been measured for a predetermined period right before the current measurement values.

15. The method of claim 11, wherein the machine learning algorithm is trained based on a relationship between the current and voltage.

16. The method of claim 15, wherein the relationship is defined by an equation:
$$I = {I}_{0} [ {e}^{\frac{q V}{n k T}} - 1 ] - IL ,$$
where I is a predicted current value, I₀ is a previous current value, Vis a currently measured voltage value, k is a Boltzmann constant, Tis an absolute temperature in Kelvin, q is an elementary charge, n is an ideality factor, which is 1 for indirect semiconductors and 2 for direct semiconductors, and IL is light illumination.

17. The method of claim 16, wherein the machine learning algorithm is updated based on the predicted current value and the current measurement current value.

18. The method of claim 16, wherein the machine learning algorithm is updated by adjusting parameters in the equation.

19. The method of claim 11, wherein controlling the power plant is performed by allocating a power set point for each inverter based on an estimated PHL for the power plant.

20. A system for controlling a power plant by estimating a potential high limit (PHL) of the power plant, the system comprising:
one or more processors; and
a memory including instructions that, when executed by the one or more processors, cause the system to:
generate synthetic data based on a plurality of predetermined models, each of which is for an environment in a power plant;
train a machine learning algorithm with the synthetic data;
receive current measurement values of current and voltage at inverters of the power plant during a curtailment period;
build a model of the function relationship between current and voltage, by the machine learning algorithm, based on previous measurement values and current measurement values;
based on the built model, estimate the PHL at the inverters, by the machine learning algorithm; and
control the power plant, based on the estimated PHL.
